(19) United States
(12) Patent Application Publication
(10) Pub. No.: US 2021/0306394 A1
(43) Pub. Date: Sep. 30, 2021

(54) Media Playback Control Method and System, and Computer Readable Medium

(71) Applicant: XI'AN NOVASTAR TECH CO., LTD., No.72, 2nd Keji Road (CN)

(72) Inventors: Jingguo ZONG, XI'AN, Shaanxi (CN); Dan HAN, XI'AN, Shaanxi (CN); Haitian ZHU, XI'AN, Shaanxi (CN); Pengcheng ZHANG, XI'AN, Shaanxi (CN)

(21) Appl. No.: 16/772,814

(22) PCT Filed: Dec. 13, 2018
(86) PCT No.: PCT/CN2018/120851

§ 371 Date: Jun. 15, 2020

(51) Int. Cl. H04L 29/06; G06F 3/0484

(52) U.S. Cl. CPC H04L 65/60; G06F 3/0484

(57) ABSTRACT

The present disclosure discloses a media playback control method and system, and a computer readable medium. Specifically, within a target time period of a playlist, at least one page in the target time period is played, wherein a window of a designated page in the at least one page is associated with a sublist and the sublist is associated with multiple media; and when the window of the designated page is played, a media identifier is taken out, according to a preset playback manner of the sublist, from a media playback management list corresponding to the sublist, and the media corresponding to the media identifier is played in the window of the designated page after the media identifier is taken out, wherein the media playback management list includes media identifiers of the multiple media.

### TECHNICAL FIELD

The present disclosure relates to the technical field of media playback control, and in particular to a media playback control method, a media playback control system and a computer readable medium.

### BACKGROUND

An Android platform has been gradually applied to a mobile embedded operation device because of its prominent openness, and consequently, a display screen (including but not limited to an Liquid Crystal Display (LCD) screen and a Light Emitting Diode (LED) display screen) asynchronous control system based on the Android platform has a wide market application prospect. In, playback control software developed based on the Android platform, a media includes but not limited to a picture, a text, a video, a Word document, an Excel form, a PowerPoint slide, a weather forecast, a digital clock, etc. With characteristics of portability, usability, embeddability and the like of the asynchronous control system, there is a huge development space for an LED asynchronous control system in the field of playback control. In this sense, it is necessary for the playback control software to schedule and play the media in a manner of being reasonable, simple and more adapted for a market requirement, thus achieving a better playback effect and generating better advertisement playback effect and economic value.

In a program organizational form used by the existing playback control software that is developed based on the Android platform, a playlist has multiple time periods, each time period has multiple pages, each page has multiple windows, and each window has multiple media. Wherein each time period has a time constraint and each page has a certain playback rule.

However, within constricted time of the time period, the page and the media in the window can only be played sequentially, and the multiple media cannot be selected sequentially or randomly for playback. Therefore, such a technical solution has a large limitation. Additionally, as a media playback logic is sequential playback, a program played in each round of the produced playlist is the same, which results in poor flexibility of program playback and a poor user experience.

### SUMMARY

In an aspect, the media playback control method provided by the embodiments of the present disclosure may include that: within a target time period of a playlist, at least one page in the target time period is played, wherein a window of a designated page in the at least one page is associated with a sublist and the sublist is associated with the multiple media; and when the window of the designated page is played, a media identifier is taken out, according to a preset playback manner of the sublist, from a media playback management list corresponding to the sublist, and the media corresponding to the media identifier is played in the window of the designated page after the media identifier is taken out, wherein the media playback management list includes media identifiers of the multiple media. In the embodiment, by embedding the sublist into the playlist, a freer media playback manner is provided for a user, a combination manner of a program is enriched greatly, and thus the user experience is good.

In an alternative embodiment of the present disclosure, the step that the media identifier is taken out, according to a preset playback manner of the sublist, from the media playback management list corresponding to the sublist, and the media corresponding to the media identifier is played in the window of the designated page after the media identifier is taken out may include that: (I) the media identifier is taken out from the media playback management list according to a sequential playback manner, the media corresponding to the media identifier is played in the window of the designated page after the media identifier is taken out, and the media identifier is deleted from the media playback management list; or (II) the media identifier is taken out from the media playback management list according to a random playback manner, the media corresponding to the media identifier is played in the window of the designated page after the media identifier is taken out, and the media identifier is deleted from the media playback management list; or the media identifier is taken out from the media playback management list according to a random playback manner, and the media corresponding to the media identifier is played in the window of the designated page after the media identifier is taken out but the media identifier is not deleted from the media playback management list; or (III) the media identifier is taken out from the media playback management list according to a probability playback manner, and the media corresponding to the media identifier is played in the window of the designated page after the media identifier is taken out but the media identifier is not deleted from the media playback management list, wherein the probability playback manner is a probability that the multiple media associated with the sublist are respectively and randomly selected; or (IV) the media identifier is taken out from the media playback management list according to a relationship playback manner, and the media corresponding to the media identifier is played in the window of the designated page after the media identifier is taken out but the media identifier is not deleted from the media playback management list, wherein the relationship playback manner is a playback sequence dependency relationship preset among the multiple media associated with the sublist; or (V) the media identifier is taken out from the media playback management list according to a number-of-times playback manner, the media corresponding to the media identifier is played in the window of the designated page after the media identifier is taken out, and the media identifier is deleted from the media playback management list when the number of times for taking out the media identifier is equal to the preset number of times. In this way, by designing multiple playback manners for the sublist, great convenience is provided for selection of the user, and the user experience is improved.

In the embodiment of the present disclosure, the media playback control method may further include that: whether current system time meets a time constraint of the at least one time period in the playlist is detected in real time; and if a detection result is that the current system time meets the time constraint of the at least one time period in the playlist, one time period is determined from the at least one time period as the target time period, wherein a time period having a high priority is determined as the target time period when the at least one time period is multiple time periods. With such a manner, a solution is provided for selection of the target time period and an optimized solution is provided when multiple time periods meet the time constraint simultaneously.

In another aspect, the embodiments of the present disclosure provide a media playback control method, which may include that: within a target time period of a playlist, at least one page in the target time period is played, wherein the at least one page includes a target page, the target page simultaneously follows a page playback rule of the target page and a window playback rule of each window in the target page for the media playback, the target page has at least one window and each window has at least one media; in a process of playing the target page, the number of playback times for each media in each window of the target page is counted, the number of playback times of each window in the target page is counted and the number of playback times of the target page is counted; and a media playback position in each window of the target page is recorded with a unique identification number of the window as an index at the end of the playback of the target page, so as to use when the target page is played at the next time within the target time period. In the embodiment, a playback scheduling mechanism is implemented by increasing the window playback rule and re-designing a page scheduling module; by means of the scheduling mechanism, the media playback may be controlled reasonably and simply, and the media may be guaranteed to be played as per a use scenario of the user; and thus, a display screen asynchronous control device may be adapted for more application scenarios and action modes, the diversity of a played content is greatly increased, the utilization rate of a display screen is improved, and at last, a better playback effect is achieved, and better advertisement playback effect and economic value are generated.

In the embodiment of the present disclosure, the media playback control method may further include that: in a process of playing the target page at the next time within the target time period, the recorded media playback position of the window is taken out according to the unique identification number of each window, and the corresponding media is taken out according to the media playback position to play in the window. Therefore, according to the recorded media playback position, completely sequential playback, completely random playback, sequential playback N or random playback N of the media in the window may be implemented.

In still another aspect, the embodiments of the present disclosure provide a media playback control method, which may include that: within a target time period of a playlist, a target page in the target time period is played, wherein the target page includes a first window and a second window, the first window has at least one media, the second window is associated with a sublist, and the sublist is associated with the multiple media via the media identifier in the media playback management list; in a process of playing the target page, the number of playback times for each media in the first window of the target page is counted, the number of playback times of the first window is counted and the number of playback times of the target page is counted, and the media playback position in the first window is recorded with a unique identification number of the first window as an index at the end of the playback of the target page, so as to use when the target page is played at the next time within the target time period; and in a process of playing the target page, the media identifier is taken out from the media playback management list according to a preset playback manner of the sublist, and the media corresponding to the media identifier is played in a second window after the media identifier is taken out. The embodiment implements a technical solution in which different playback rules are used for the media in different windows of a same page, which is helpful for fusion of the multiple media playback rules.

In still another aspect, the embodiments of the present disclosure provide a media playback control system, which may include: a memory, configured to store a program code; and a processor, connected to the memory, and configured to invoke the program code stored in the memory to execute the above-mentioned any media playback control method.

In still another aspect, the embodiments of the present disclosure provide a computer readable medium, which stores a computer executable instruction for executing the above-mentioned any media playback control method.

### BRIEF DESCRIPTION OF THE DRAWINGS

In order to describe the technical solutions in the embodiments of the present disclosure more clearly, a simple introduction on the accompanying drawings which are needed in the description of the embodiments or conventional art is given below. Apparently, the accompanying drawings in the description below are merely some of the embodiments of the present disclosure, based on which other drawings may be obtained by those of ordinary skill in the art without any creative effort.

FIG. 1 is a schematic flowchart of a media playback control method according to a first embodiment of the present disclosure.

FIG. 2 is a schematic diagram of a playlist organizational form according to a first embodiment of the present disclosure.

FIG. 3 is a modular schematic diagram of a media playback control device according to a first embodiment of the present disclosure.

FIG. 4 is a structural block diagram of a page counting module shown in FIG. 3.

FIG. 5 is a schematic diagram of a specific example of a playlist organizational form according to a first embodiment of the present disclosure.

FIG. 6 is a schematic diagram of another specific example of a playlist organizational form according to a first embodiment of the present disclosure.

FIG. 7 is a schematic diagram of still another specific example of a playlist organizational form according to a first embodiment of the present disclosure.

FIG. 8 is a schematic flowchart of a media playback control method according to a second embodiment of the present disclosure.

FIG. 9 is a schematic diagram of a page organizational form in a time period of a playlist according to a second embodiment of the present disclosure.

FIG. 10A to FIG. 10E are a schematic diagram of multiple different playback manners of a sublist according to a second embodiment of the present disclosure.

FIG. 11 is a modular schematic diagram of a media playback control device according to a second embodiment of the present disclosure.

FIG. 12 is a schematic flowchart of a media playback control method according to a third embodiment of the present disclosure.

FIG. 13 is a structural schematic diagram of a media playback control system according to a fourth embodiment of the present disclosure.

FIG. 14 is a schematic diagram of a computer readable medium according to a fifth embodiment of the present disclosure.

FIG. 15 is a schematic diagram of a playlist organizational form according to other embodiments of the present disclosure.

FIG. 16 is a schematic diagram of another playlist organizational form according to other embodiments of the present disclosure.

FIG. 17 is a schematic diagram of still another playlist organizational form according to other embodiments of the present disclosure.

### DETAILED DESCRIPTION OF THE EMBODIMENTS

The technical solutions in the embodiments of the present disclosure will be clearly and completely described hereinafter with the drawings in the embodiments of the present disclosure. It is apparent that the described embodiments are only part of the embodiments of the present disclosure, not all of the embodiments. All other embodiments obtained by a person of ordinary skill in the art based on the embodiments of the present disclosure without creative efforts shall fall within the protection scope of the present disclosure.

### Embodiment 1

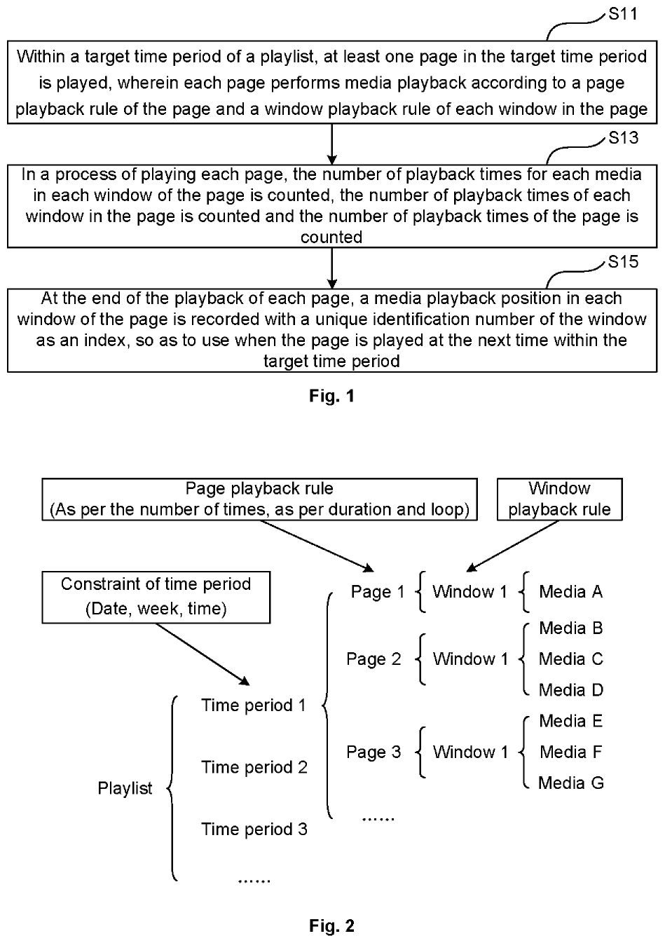

As shown in FIG. 1, a media playback control method provided by the first embodiment of the present disclosure includes the following steps.

At S11: within a target time period of a playlist, at least one page in the target time period are played, wherein each page performs the media playback according to a page playback rule of the page and a window playback rule of each window in the page.

At S13: in a process of playing each page, the number of playback times for each media in each window of the page is counted, the number of playback times of each window in the page is counted and the number of playback times of the page is counted.

At S15: at the end of the playback of each page, a media playback position in each window of the page is recorded with a unique identification number of the window as an index, so as to use when the page is played at the next time within the target time period.

As stated above, the page playback rule related in step S11 is, for example, selected from playback as per the number of times, playback as per a duration and loop playback; the window playback rule is, for example, selected from completely sequential playback, completely random playback, sequential playback N and random playback N; wherein the N is a natural number and the N represents the number of the media to be selected in the window.

Further, the media playback control method in the embodiment of the present disclosure may further include that: in a process of playing the page at the next time within the target time period, the recorded media playback position of the window is taken out according to the unique identification number of each window, and the corresponding media is taken out according to the media playback position to play in the window.

Additionally, the media playback control method in the embodiment of the present disclosure may further include that: whether current system time meets a time constraint of at least one time period in the playlist is detected in real time; and if a detection result is that the current system time meets the time constraint of the at least one time period in the playlist, one time period is determined from the at least one time period as the target time period.

For the ease of understanding the media playback control method in the embodiment more clearly, a detailed description is given below in combination with FIG. 2 to FIG. 7.

In the embodiment, for example, the media playback control method is implemented by playback control software developed based on an Android platform. Specifically, a media collective-scheduling mechanism having a playback rule is proposed. The playback control software may control the media playback reasonably and simply by means of the mechanism, thus ensuring that the media may be played according to a use scenario of a user, and a display screen asynchronous control device is adapted to more application scenarios and action modes.

Referring to FIG. 2, it is a schematic diagram of a playlist organizational form in the embodiment. As shown in FIG. 2, the playlist has at least one time period, such as a time period 1, a time period 2, a time period 3, etc. Each time period has at least one page. For example, the time period 1 has a page 1, a page 2, a page 3, etc. Each page has at least one window. For example, the page 1 has a window 1, the page 2 has the window 1 and the page 3 has the window 1. Each window also has at least one media. For example, the window 1 in the page 1 has a media A, the window 1 in the page 2 has a media B, a media C and a media D, and the window 1 in the page 3 has a media E, a media F and a media G. Further, there is a time constraint for the time period. For example, the time constraint is a date constraint, a week constraint or a time constraint. The page has a certain playback rule. For example, the playback rule is playback as per the number of times, playback as per a duration or loop playback.

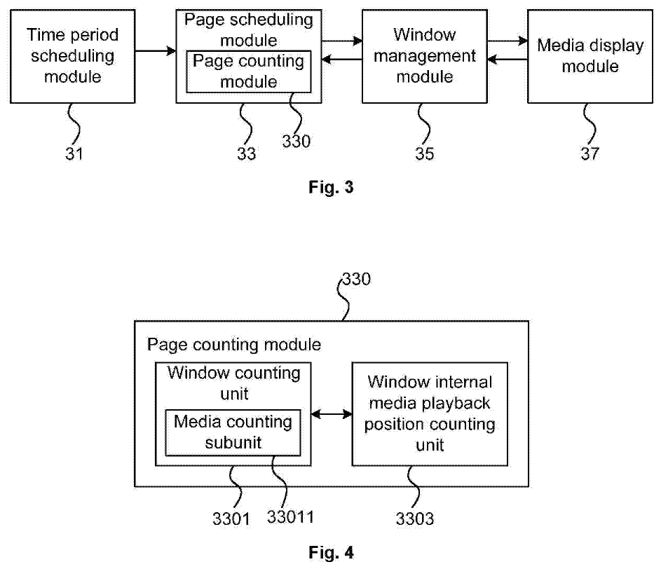

In addition, the playlist organizational form shown in FIG. 2 in the embodiment is further designed with a window playback rule. The window playback rule includes but not limited to “completely sequential playback”, “completely random playback”, “sequential playback N”, “random playback N”, etc. The overall block diagram of the scheduling mechanism is as shown in FIG. 3.

Specifically, in a media playback control device shown in FIG. 3, a time period scheduling module 31 is configured to detect, in real time, whether current system time is effective, i.e., whether the current system time meets a time constraint of at least one time period in a playlist; and stop, if the current system time does not meet a time constraint of a playing time period, playback in the time period. Particularly, if the current system time meets time constraints of multiple time periods, a time period having a high priority is played priorly. A page scheduling module 33 is configured to perform page scheduling according to a page playback rule and a window playback rule; and a page counting module 330 is provided in the page scheduling module 33. A window management module 35 is configured to manage each media in a window to play according to the window playback rule. A media display module 37 is configured to complete correct playback and display of the current media. Herein, it may be understood that the time period scheduling module 31, the page scheduling module 33, the window management module 35 and the media display module 37 are typically software modules. They may be stored in a computer system such as a memory of a display screen asynchronous control device, and executed by an embedded processor (such as an ARM) of the display screen asynchronous control device, thus completing playback control on the media in the playlist.

As stated above, a structural block diagram of the page counting module 330 is as shown in FIG. 4. A media counting subunit 33011 is configured to count the number of playback times of each media in each window, so that a window counting unit 3301 may count the number of playback times of each window in the page based on a counting result of the media counting subunit 33011, and at last, the page counting module 330 counts the number of playback times of each page based on a counting result of the window counting unit 3301. A window internal media playback position counting unit 3303 is configured to record a media playback position in the window with an ID (unique identification number) of the window as an index at the end of the playback of a page under a special window playback rule. As a consequence, when the page is played at the next time, the page scheduling module 33 takes out, from the window internal media playback position counting unit 3303, the recorded media playback position in the window at the previous time according to the ID of the window, and transmits the recorded media playback position to the window management module 35; and then, the window management module 35 continues to take out the corresponding media from the media playback position to play in the window.

### Example 1

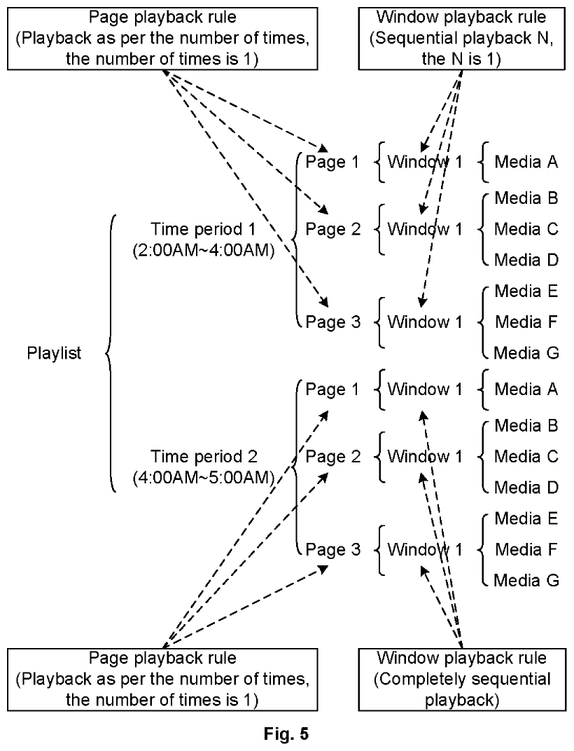

One display screen asynchronous control device is provided, with a playlist organizational format as shown in FIG. 5. In order to verify the effectiveness of the playback scheduling mechanism in the embodiment, a specific implementation manner of the verification work is designed as the following steps.

(1) The display screen asynchronous control device is started at 1:00 AM. At this time, as the system time does not meet the constraint of any time period in the playlist, the display screen asynchronous control device does not play a program.

(2) When the system time reaches 2:00 AM, the system time meets a time constraint of a time period 1 and playback for a program in the time period 1 is started. The time period 1 has three pages (i.e., a page 1, a page 2 and a page 3), and the page playback rule is playback as per the number of times and the number of times is 1. The window playback rule in the page is “sequential playback N”; and at this time, the N is 1 and the N is the number of the media to be selected. During a 2:00 AM-4:00 AM time period, it may be observed that a media playback sequence is ABEACFADGABEACFADG . . . .

(3) When the system time reaches 4:00 AM, the system time meets a time constraint of a time period 2 and playback for a program in the time period 2 is started. The time period 2 has three pages (i.e., a page 1, a page 2 and a page 3), and the page playback rule is playback as per the number of times and the number of times is 1. The window playback rule in the page is “completely sequential playback”. During a 4:00 AM-5:00 AM time period, it may be observed that the media playback sequence is ABCDEFGABCDEFG . . . .

### Example 2

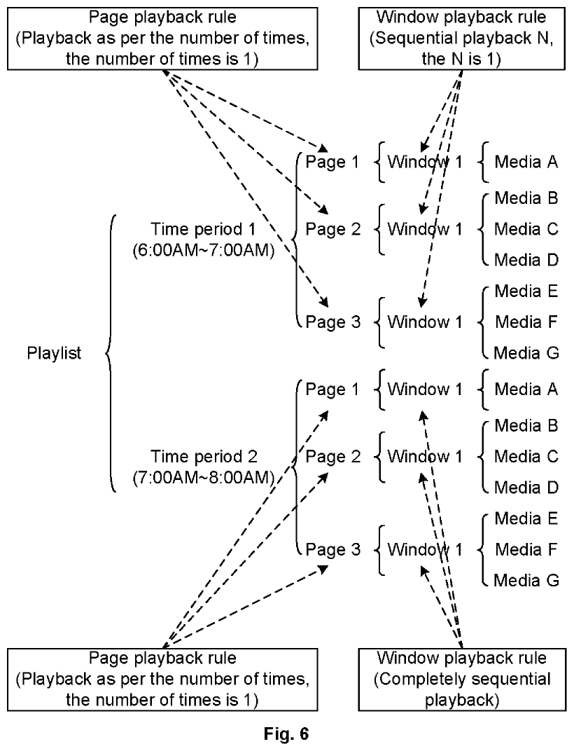

One display screen asynchronous control device is provided, with a playlist organizational format as shown in FIG. 6. In order to verify the effectiveness of the playback scheduling mechanism in the embodiment, a specific implementation manner of the verification work is designed as the following steps.

(1) The display screen asynchronous control device is started at 5:00 AM. At this time, as the system time does not meet the constraint of any time period in the playlist, the display screen asynchronous control device does not play a program.

(2) When the system time reaches 6:00 AM, the system time meets a time constraint of a time period 1 and playback for a program in the time period 1 is started. The time period 1 has three pages (i.e., a page 1, a page 2 and a page 3), and the page playback rule is playback as per the number of times and the number of times is 1. The window playback rule in the page is “random playback N”; and at this time, the N is 1 and the N is the number of the media to be selected. During a 6:00 AM-7:00 AM time period, it may be observed that the media playback sequence is ACEABGADGABEACFADG . . . . It can be seen that when the window playback rule is the random playback N and the N is 1, and when a corresponding window is played, one media is randomly selected in the window for playback, and a count value for the number of playback times for the unselected media is 0.

(3) When the system time reaches 7:00 AM, the system time meets a time constraint of a time period 2 and playback for a program in the time period 2 is started. The time period 2 has three pages (i.e., a page 1, a page 2 and a page 3), and the page playback rule is playback as per the number of times and the number of times is 1. The window playback rule in the page is “completely sequential playback”. During a 7:00 AM-8:00 AM time period, it may be observed that the media playback sequence is ABCDEFGABCDEFG . . . .

### Example 3

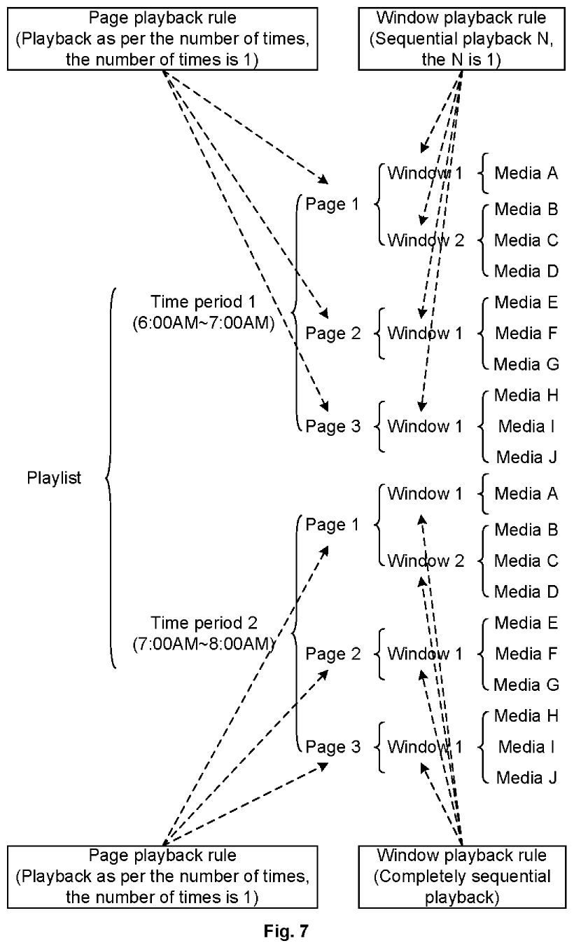

One display screen asynchronous control device is provided, with a playlist organizational format as shown in FIG. 7. In order to verify the effectiveness of the playback scheduling mechanism in the embodiment, a specific implementation manner of the verification work is designed as the following steps.

(1) The asynchronous control device is started at 5:00 AM. At this time, as the system time does not meet the constraint of any time period in the playlist, the display screen asynchronous control device does not play a program.

(2) When the system time reaches 6:00 AM, the system time meets a time constraint of a time period 1 and playback for a program in the time period 1 is started. The time period 1 has three pages (i.e., a page 1, a page 2 and a page 3), and the page playback rule is playback as per the number of times and the number of times is 1. The window playback rule in the page is “random playback N”; and at this time, the N is 1 and the N is the number of the media to be selected. During 6:00 AM-7:00 AM, the page 1, the page 2 and the page 3 are played sequentially. The page 1 has two windows and it may be observed that the window 1 plays the media A, the window 2 randomly selects one media from the media B, C and D for playback, and upon the completion of the playback of the window 1 and the window 2, the page 1 completes the playback and is switched to the page 2. The page 2 only has one window, and it may be observed that any media is selected from the media E, F and G of the window 1 for playback, and upon the completion of the playback of the window 1, the page 2 completes the playback and is switched to the page 3. The page 3 only has one window, and it may be observed that any media is selected from the media H, I and J of the window 1 for playback, and upon the completion of the playback of the window 1, the page 3 completes the playback and then is switched to the page 1; and that cycle repeats within a time range of the time period 1. It can be seen that when the window playback rule is the “random playback N” and the N is 1, and when a corresponding window is played, one media is randomly selected in the window for playback.

(3) When the system time reaches 7:00 AM, the system time meets a time constraint of a time period 2 and playback for a program in the time period 2 is started. The time period 2 has three pages (i.e., a page 1, a page 2 and a page 3), and the page playback rule is playback as per the number of times and the number of times is 1. The window playback rule in the page is “completely sequential playback”. During 7:00 AM-8:00 AM, the page 1, the page 2 and the page 3 are played sequentially. The page 1 has two windows and it may be observed that the window 1 plays the media A, the window 2 sequentially plays the media B, C and D, and upon the completion of the playback of the window 1 and the window 2, the page 1 completes the playback and is switched to the page 2. The page 2 only has one window, and it may be observed that the window 1 sequentially plays the media E, F and G, and upon the completion of the playback of the window 1, the page 2 completes the playback and is switched to the page 3. The page 3 only has one window, and it may be observed that the window 1 sequentially plays the media H, I and J, and upon the completion of the playback of the window 1, the page 3 completes the playback and then is switched to the page 1; and that cycle repeats within a time range of the time period 2. It can be seen that when the window playback rule is the “completely sequential playback”, and when a corresponding window is played, all the media in the window are played sequentially.

To sum up, a media playback scheduling mechanism is proposed by the first embodiment of the present disclosure. The playback control software may control the media playback reasonably and simply by means of the mechanism, thus ensuring that the media may be played according to a use scenario of a user, and the display screen asynchronous control device is adapted to more application scenarios and action modes. For example, when a customer purchases an advertising position at unit time, it is expected by the customer that the advertising position is not limited to play a same advertisement content only but multiple advertisements may be produced by the customer simultaneously to place into the purchased advertising position. At this time, the window playback rule is set as the “random playback N and the N is 1”. Once playing to the advertising position of the customer, the display screen selects one of the multiple advertisements of the customer for playback, so that the diversity of a played content is greatly increased, the utilization rate of the display screen is improved, and at last, a better playback effect is achieved, and better advertisement playback effect and economic value are generated. Further, by means of setting the window playback rule, the media is prevented from being added repeatedly, so that the size of the program in the playback solution is saved, the memory is saved, the traffic transmission is saved, and more flexible playback scheduling is implemented.

Additionally, it is to be noted that the playback control software in the foregoing first embodiment is developed based on the Android platform but the embodiment of the present disclosure is not limited thereto. The playback control software may also be developed and designed based on other system platforms such as a WinCE platform; and further, the media playback control method and device in the embodiment of the present disclosure are also not only limited to be applied to the display screen asynchronous device, and may also be applied to an upper computer of a display screen synchronous control system.

### Embodiment 2

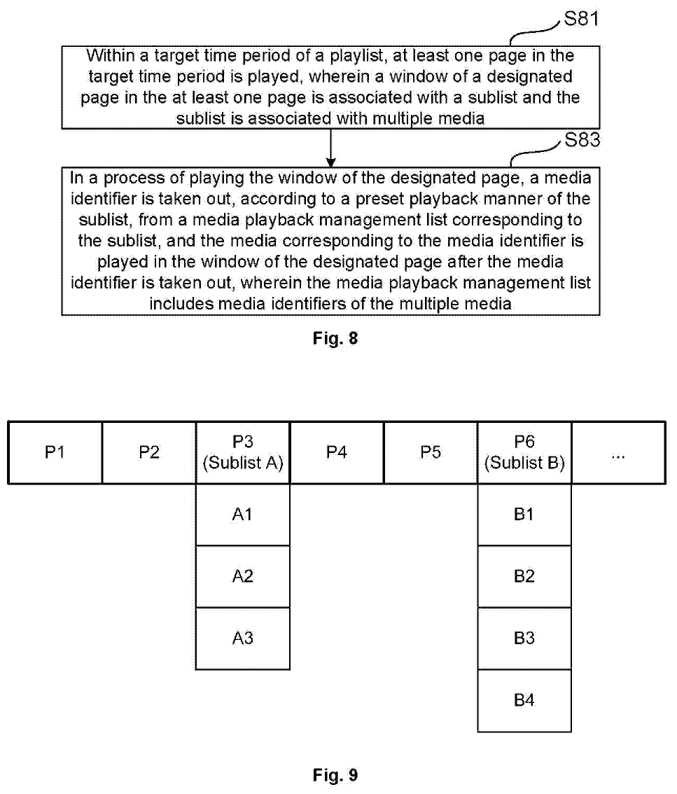

As shown in FIG. 8, a media playback control method provided by the second embodiment of the present disclosure includes the following steps.

At S81: within a target time period of a playlist, at least one page in the target time period is played, wherein a window of a designated page in the at least one page is associated with a sublist and the sublist is associated with the multiple media.

At S83: in a process of playing the window of the designated page, a media identifier is taken out, according to a preset playback manner of the sublist, from a media playback management list corresponding to the sublist, and the media corresponding to the media identifier is played in the window of the designated page after the media identifier is taken out, wherein the media playback management list includes the media identifiers of the multiple media.

As stated above, in step S81, the page organizational form in the target time period of the playlist is, for example, as shown in FIG. 9. The target time period has multiple pages such as P1, P2, P3, P4, P5, P6, etc. The window of the page P3 is, for example, associated with a sublist A, and the window of the page P6 is, for example, associated with a sublist B. The sublist A is, for example, associated with the media corresponding to the multiple media numbers of A1, A2 and A3, and the sublist B is, for example, associated with the media corresponding to the multiple media numbers of B1, B2, B3 and B4. Additionally, it may be understood that the window of the page P3 may also be associated with the media located at a same level with the sublist A beside the sublist A in other embodiments. Likewise, beside the sublist B, the window of the page P6 may also be associated with the media located at a same level with the sublist B.

In step S83, the preset playback manner of the sublist is, for example, a sequential playback manner, a random playback manner, a probability playback manner, a relationship playback manner or a number-of-times playback manner. It is assumed that the sublist is associated with N media, and correspondingly has N media identifiers such as N media numbers.

(i) Sequential playback manner: the media number is taken out sequentially from the N media numbers and the media number that is taken out sequentially is not repeated, i.e., prior to complete playback of the N media associated by the sublist, the repeated media number is not taken.

(ii) Random playback manner: it is divided into a true random manner and a pseudo-random manner. The true random manner is refers to that the media number is taken out randomly from the N media numbers, and the media number that is taken out randomly may have the repeated media number, i.e., during the complete playback of the N media associated by the sublist, the same media number may be taken for multiple times. The pseudo-random manner refers to that the media number is taken out randomly from the N media numbers, and the media number that is taken out randomly is not repeated, i.e., prior to the complete playback of the N media associated by the sublist, the repeated media number is not taken.

(iii) Probability playback manner: a probability that each media in the N media is randomly selected may be set so as to randomly take the media number at the set probability. During the complete playback of the N media associated by the sublist, the media number that is taken out may be repeated, and the same media number may be taken for multiple times.

(iv) Relationship playback manner: a dependency relationship may be set to obtain the media numbers of the N media associated by the sublist. For example, it is set that after the media number A1 is taken out, the media number A3 is taken out certainly at the next time.

(v) Number-of-times playback manner: the number of times that each media in the N media is taken out may be set. After the playback for the number of times, prior to the complete playback of the N media associated by the sublist, the media number corresponding to the media is not taken.

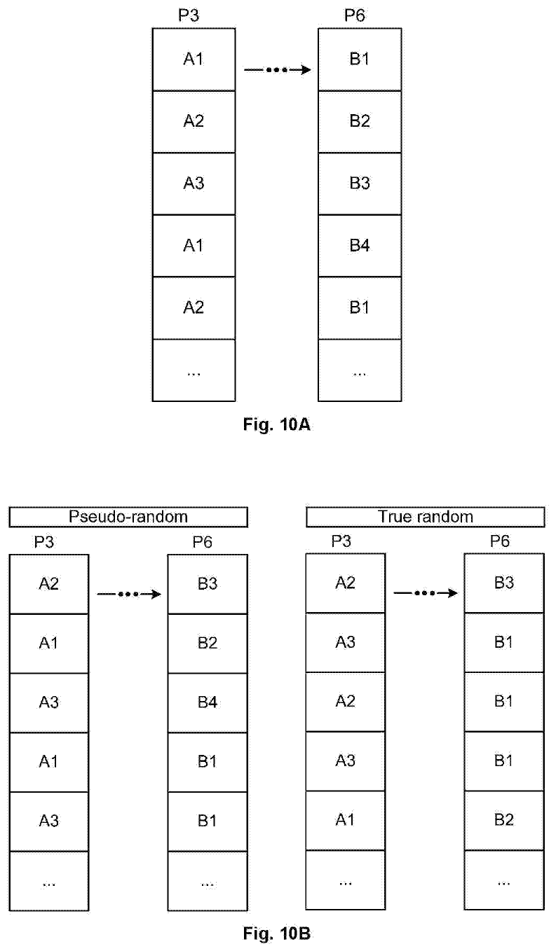

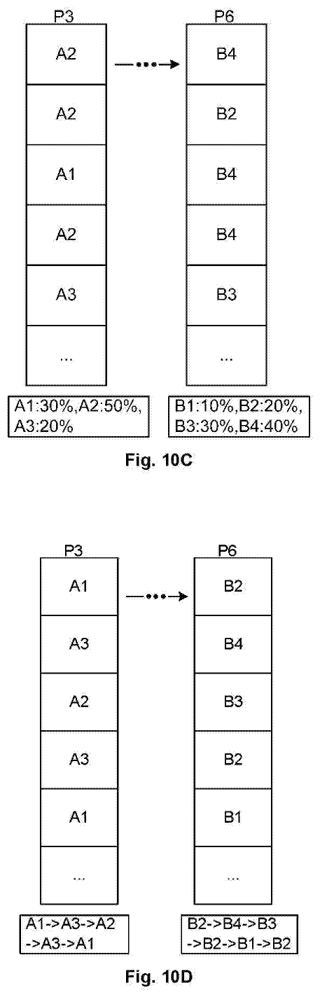

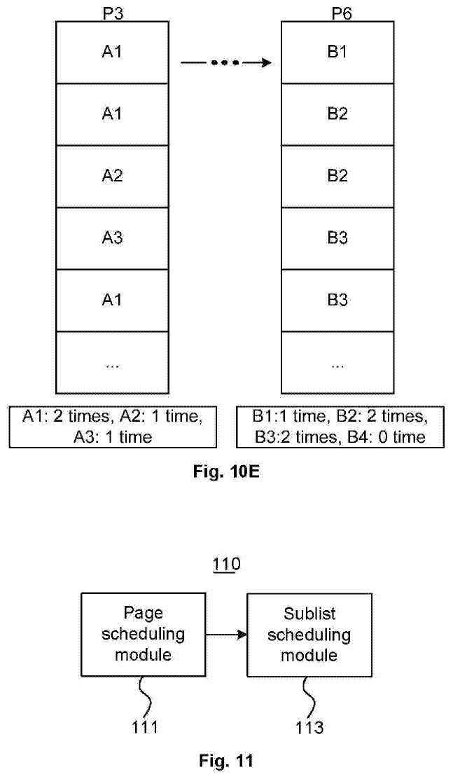

For the ease of understanding each playback manner of the sublist related in the embodiment more clearly, a detailed description is given below in combination with FIG. 9 and FIGS. 10A-10E.

(X1) As can be seen in combination with FIG. 9 and FIG. 10A, in a process of playing the page P3 for a first time after the page P2 is played, the media number A1 (one of the media identifiers) is taken out from a media playback management list corresponding to the sublist A, a media corresponding to the media number A1 is played in the page P3 after the media number A1 is taken out, and the media number A1 is deleted from the media playback management list. At this time, there only remain the media numbers A2 and A3 in the media playback management list. Thereafter, in a process of playing the page P3 for a second time, the media number A2 is taken out from the media playback management list corresponding to the sublist A, a media corresponding to the media number A2 is played in the page P3 after the media number A2 is taken out, and the media number A2 is deleted from the media playback management list. At this time, there only remains the media number A3 in the media playback management list; and by parity of reasoning, the media number is taken out according to a sequence shown in FIG. 10A, so that the sequential playback for the media A1, A2 and A3 associated by the sublist A is implemented in the target time period.

Similarly, in a process of playing the page P6 for a first time after the page P5 is played, the media number B1 is taken out from the media playback management list corresponding to the sublist B, the media corresponding to the media number B1 is played in the page P6 after the media number B1 is taken out, and the media number B1 is deleted from the media playback management list. At this time, there only remain the media numbers B2, B3 and B4 in the media playback management list. Thereafter, in a process of playing the page P6 for a second time, the media number B2 is taken out from the media playback management list corresponding to the sublist B, the media corresponding to the media number B2 is played in the page P6 after the media number B2 is taken out, and the media number B2 is deleted from the media playback management list. At this time, there only remain the media numbers B3 and B4 in the media playback management list; and by parity of reasoning, the media number is taken out according to the sequence shown in FIG. 10A, so that the sequential playback for the media B1, B2, B3 and B4 associated by the sublist B is implemented in the target time period.

(X2) As can be seen in combination with FIG. 9 and FIG. 10B, for a pseudo-random playback manner, in a process of playing the page P3 for a first time, the media number A2 is randomly taken out from the media numbers A1 to A3 in the media playback management list corresponding to the sublist A, the media corresponding to the media number A2 is played in the page P3 after the media number A2 is taken out randomly, and the media number A2 is deleted from the media playback management list. At this time, there only remain the media numbers A1 and A3 in the media playback management list. Thereafter, in a process of playing the page P3 for a second time, the media number A1 is randomly taken out from the media numbers A1 and A3 in the media playback management list corresponding to the sublist A, the media corresponding to the media number A1 is played in the page P3 after the media number A1 is randomly taken out, and the media number A1 is deleted from the media playback management list. At this time, there only remains the media number A3 in the media playback management list; and by parity of reasoning, the media number is taken out according to a sequence shown in FIG. 10B, so that the pseudo-random playback for the media A1, A2 and A3 associated by the sublist A is implemented in the target time period.

For a true random playback manner, in a process of playing the page P3 for a first time, the media number A2 is randomly taken out from media numbers A1 to A3 in a media playback management list corresponding to the sublist A, a media corresponding to the media number A2 is played in the page P3 after the media number A2 is taken out randomly, but the media number A2 is not deleted from the media playback management list. At this time, there still remain the media numbers A1 to A3 in the media playback management list. Thereafter, in a process of playing the page P3 for a second time, the media number A3 is randomly taken out from the media numbers A1 to A3 in the media playback management list corresponding to the sublist A, the media corresponding to the media number A3 is played in the page P3 after the media number A3 is randomly taken out, but the media number A3 is not deleted from the media playback management list. At this time, there still remain the media numbers A1 to A3 in the media playback management list; and by parity of reasoning, the media number is taken out according to the sequence shown in FIG. 10B, so that the true random playback for the media A1, A2 and A3 associated by the sublist A is implemented in the target time period.

Similarly, for the pseudo-random playback manner, in a process of playing the page P6 for a first time, the media number B3 is randomly taken out from the media numbers B1 to B4 in the media playback management list corresponding to the sublist B, the media corresponding to the media number B3 is played in the page P6 after the media number B3 is taken out randomly, and the media number B3 is deleted from the media playback management list. At this time, there only remain the media numbers B1, B2 and B4 in the media playback management list. Thereafter, in a process of playing the page P6 for a second time, the media number B2 is randomly taken out from the media numbers B1, B2 and B4 in the media playback management list corresponding to the sublist B, the media corresponding to the media number B2 is played in the page P6 after the media number B2 is randomly taken out, and the media number B2 is deleted from the media playback management list. At this time, there only remain the media numbers B1 and B4 in the media playback management list; and by parity of reasoning, the media number is taken out according to the sequence shown in FIG. 10B, so that the pseudo-random playback for the media B1, B2, B3 and B4 associated by the sublist B is implemented in the target time period.

For the true random playback manner, in a process of playing the page P6 for a first time, the media number B3 is randomly taken out from the media numbers B1 to B4 in the media playback management list corresponding to the sublist B, the media corresponding to the media number B3 is played in the page P6 after the media number B3 is taken out randomly, but the media number B3 is not deleted from the media playback management list. At this time, there still remain the media numbers B1 to B4 in the media playback management list. Thereafter, in a process of playing the page P6 for a second time, the media number B1 is randomly taken out from the media numbers B1 to B4 in the media playback management list corresponding to the sublist B, the media corresponding to the media number B1 is played in the page P6 after the media number B1 is randomly taken out, but the media number B1 is not deleted from the media playback management list. At this time, there still remain the media numbers B1 to B4 in the media playback management list; and by parity of reasoning, the media number is taken out according to the sequence shown in FIG. 10B, so that the true random playback for the media B1, B2, B3 and B4 associated by the sublist B is implemented in the target time period.

(X3) As can be seen in combination with FIG. 9 and FIG. 10C, it is assumed that the probability of each media in the sublist A is: A1:30%, A2:50% and A3:20%; in a process of playing the page P3 for a first time, the media number A2 is taken out, as per the probability, from the media playback management list corresponding to the sublist A, the media corresponding to the media number A2 is played in the page P3 after the media number A2 is taken out, but the media number A2 is not deleted from the media playback management list. At this time, there still remain the media numbers A1 to A3 in the media playback management list. Thereafter, in a process of playing the page P3 for a second time, the media number A2 is taken out, as per the probability, from the media numbers A1 to A3 in the media playback management list corresponding to the sublist A, the media corresponding to the media number A2 is played in the page P3 after the media number A2 is taken out, but the media number A2 is not deleted from the media playback management list. At this time, there still remain the media numbers A1 to A3 in the media playback management list; and by parity of reasoning, the media number is taken out according to a sequence shown in FIG. 10C, so that the probability playback for the media A1, A2 and A3 associated by the sublist A is implemented in the target time period.

Similarly, it is assumed that the probability of each media in the sublist B is: B1:10%, B2:20%, B3:30%, and B4:40%; in a process of playing the page P6 for a first time, the media number B4 is taken out, as per the probability, from the media playback management list corresponding to the sublist B, the media corresponding to the media number B4 is played in the page P6 after the media number B4 is taken out, but the media number B4 is not deleted from the media playback management list. At this time, there still remain the media numbers B1 to B4 in the media playback management list. Thereafter, in a process of playing the page P6 for a second time, the media number B2 is taken out, as per the probability, from the media numbers B1 to B4 in the media playback management list corresponding to the sublist B, the media corresponding to the media number B2 is played in the page P6 after the media number B2 is taken out, but the media number B2 is not deleted from the media playback management list. At this time, there still remain the media numbers B1 to B4 in the media playback management list; and by parity of reasoning, the media number is taken out according to the sequence shown in FIG. 10C, so that the probability playback for the media B1, B2, B3 and B4 associated by the sublist B is implemented in the target time period.

(X4) As can be seen in combination with FIG. 9 and FIG. 10D, it is assumed that the playback sequence dependency relationship of each media in the sublist A is: A1->A3->A2->A3->A1; in a process of playing the page P3 for a first time, the media number A1 is taken out, as per the dependency relationship, from the media playback management list corresponding to the sublist A, the media corresponding to the media number A1 is played in the page P3 after the media number A1 is taken out, but the media number A1 is not deleted from the media playback management list. At this time, there still remain the media numbers A1 to A3 in the media playback management list. Thereafter, in a process of playing the page P3 for a second time, the media number A3 is taken out, as per the dependency relationship, from the media numbers A1 to A3 in the media playback management list corresponding to the sublist A, the media corresponding to the media number A3 is played in the page P3 after the media number A3 is taken out, but the media number A3 is not deleted from the media playback management list. At this time, there still remain the media numbers A1 to A3 in the media playback management list; and by parity of reasoning, the media number is taken out according to a sequence shown in FIG. 10D, so that the relationship playback for the media A1, A2 and A3 associated by the sublist A is implemented in the target time period.

Similarly, it is assumed that the playback sequence dependency relationship of each media in the sublist B is: B2->B4->B3->B2->B1->B2; in a process of playing the page P6 for a first time, the media number B2 is taken out, as per the dependency relationship, from the media playback management list corresponding to the sublist B, the media corresponding to the media number B2 is played in the page P6 after the media number B2 is taken out, but the media number B2 is not deleted from the media playback management list. At this time, there still remain the media numbers B1 to B4 in the media playback management list. Thereafter, in a process of playing the page P6 for a second time, the media number B4 is taken out, as per the dependency relationship, from the media numbers B1 to B4 in the media playback management list corresponding to the sublist B, the media corresponding to the media number B4 is played in the page P6 after the media number B4 is taken out, but the media number B4 is not deleted from the media playback management list. At this time, there still remain the media numbers B1 to B4 in the media playback management list; and by parity of reasoning, the media number is taken out according to the sequence shown in FIG. 10D, so that the relationship playback for the media B1, B2, B3 and B4 associated by the sublist B is implemented in the target time period.

It is to be noted that the playback sequence dependency relationship of each media associated by the sublist may be set: according to a playback duration of each media associated by the sublist (for example, from a long duration to a short duration), according to the media type of each media associated by the sublist (for example, a video is played, and a picture or other media are played at the next time), according to an advertisement type of each media associated by the sublist (for example, a commercial advertisement is played, and a public service advertisement is played at the next time), etc.

(X5) As can be seen in combination with FIG. 9 and FIG. 10E, it is assumed that the number of playback times of each media in the sublist A is: A1: 2 times, A2: 1 time and A3: 1 time; in a process of playing the page P3 for a first time, the media number A1 is taken out from the media playback management list corresponding to the sublist A, the media corresponding to the media number A1 is played in the page P3 after the media number A1 is taken out, but the media number A1 is not deleted from the media playback management list. At this time, there still remain the media numbers A1 to A3 in the media playback management list. Thereafter, in a process of playing the page P3 for a second time, the media number A1 is taken out from the media numbers A1 to A3 in the media playback management list corresponding to the sublist A, and the media corresponding to the media number A1 is played in the page P3 after the media number A1 is taken out. However, at this time, the number of times for taking out the A1 reaches the preset 2 times, so the media number A1 is deleted from the media playback management list, and there only remain the media numbers A2 and A3 in the media playback management list; and by parity of reasoning, the media number is taken out according to a sequence shown in FIG. 10E, so that the number-of-times playback for the media A1, A2 and A3 associated by the sublist A is implemented in the target time period.

Similarly, it is assumed that the preset number of playback times for each media in the sublist B is: B1: 1 time, B2: 2 times, B3: 3 times, and B4: 0 time; in a process of playing the page P6 for a first time, the media number B1 is taken out from the media playback management list corresponding to the sublist B, and the media corresponding to the media number B1 is played in the page P6 after the media number B1 is taken out. At this time, as the number of times for taking out the B1 reaches the preset 1 time, the media number B1 is deleted from the media playback management list and there only remain the media numbers B2, B3 and B4 in the media playback management list. Thereafter, in a process of playing the page P6 for a second time, the media number B2 is taken out from the media numbers B2, B3 and B4 in the media playback management list corresponding to the sublist B, the media corresponding to the media number B2 is played in the page P6 after the media number B2 is taken out, but the media number B2 is not deleted from the media playback management list. At this time, there still remain the media numbers B2, B3 and B4 in the media playback management list; and by parity of reasoning, the media number is taken out according to the sequence shown in FIG. 10E, so that the number-of-times playback for the media B1, B2, B3 and B4 associated by the sublist B is implemented in the target time period.

At last, it is to be noted that for the above description on FIG. 10A, FIG. 10B and FIG. 10E, if all media numbers in the media playback management list are deleted (i.e., there is no media number in the media playback management list), the media number of each media corresponding to the sublist is reloaded to the media playback management list.

To sum up, by embedding the sublist into the playlist (i.e., by associating at least one page in the playlist with the sublist) in the foregoing second embodiment of the present disclosure, the program combination of the user is greatly enriched, and many playback policies are provided for the user; and moreover, a small time period during program playback may be contracted to an advertiser, so that the utilization rate of the display screen is improved, and the advertiser may also insert an own advertisement into a short program interval, and may further guarantee that the own advertisement list is played completely. In addition, it is to be noted that the scheduling rule for each page of P1, P2, P3, P4, P5, P6 and the like in the target time period in FIG. 9 may be playback as per the number of times, playback as per a duration or loop playback. Therefore, with the page P3 associated by the sublist A for example, it may be played once or played continuously for multiple times in each round. Further, in addition to the media identifier of the relevant sublist, such as the media number, the above media playback management list may further record a playback state of the media corresponding to the media identifier, for example, how many times that the media is played, i.e., the media playback management list is dynamically updated in the process of playing each media associated by the sublist. At last, it is to be noted that the above preset playback manner of the sublist is merely illustrative rather than exhaustive. For example, in the target time period, the playback manner is switched once each media of the sublist is played completely, i.e., the playback manner of the sublist in the target time period may be a combination of the above listed playback manners, or even other playback manners.

Further, referring to FIG. 11, the second embodiment of the present disclosure further provides a media playback control device 110, which includes: a page scheduling module 111 and a sublist scheduling module 113; the page scheduling module 111 is configured to execute step S81 mentioned above; and the sublist scheduling module 113 is configured to execute step S83 mentioned above. Specific functional details may be referred to the foregoing related description and are not elaborated herein.

### Embodiment 3

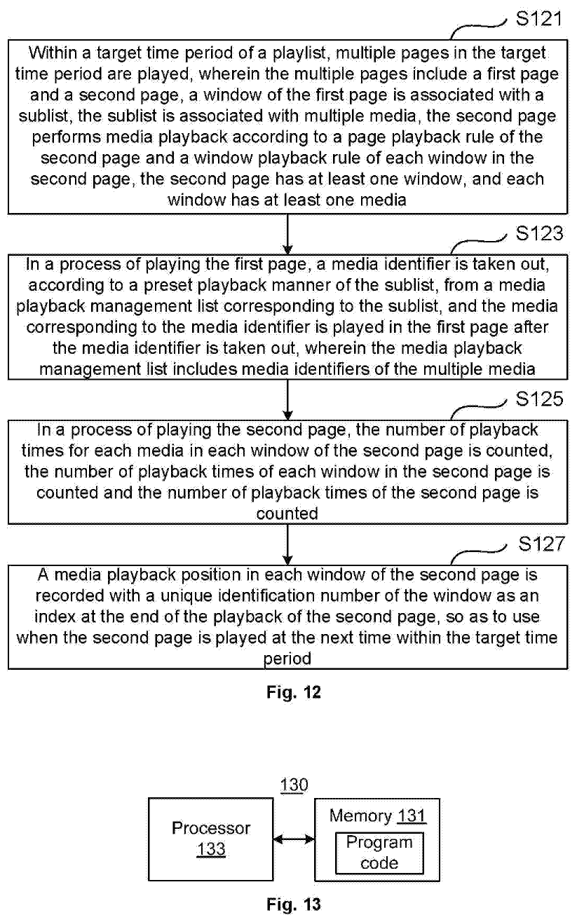

As shown in FIG. 12, a media playback control method provided by the third embodiment of the present disclosure includes the following steps.

At S121: within a target time period of a playlist, multiple pages in the target time period are played, wherein the multiple pages include a first page and a second page, a window of the first page is associated with a sublist, the sublist is associated with multiple media, the second page performs the media playback according to a page playback rule of the second page and a window playback rule of each window in the second page, the second page has at least one window, and each window has at least one media.

At S123: in a process of playing the first page, a media identifier is taken out, according to a preset playback manner of the sublist, from a media playback management list corresponding to the sublist, and the media corresponding to the media identifier is played in the first page after the media identifier is taken out, wherein the media playback management list includes media identifiers of the multiple media.

At S125: in a process of playing the second page, the number of playback times for each media in each window of the second page is counted, the number of playback times of each window in the second page is counted and the number of playback times of the second page is counted.

At S127: a media playback position in each window of the second page is recorded with a unique identification number of the window as an index at the end of the playback of the second page, so as to use when the second page is played at the next time within the target time period.

As stated above, within the target time period of the playlist, the playback of the second page may be referred to the related description on steps S11, S13 and S15 in the foregoing first embodiment, and the detailed description on the playback of the first page may be referred to the related description on steps S81 and S83 in the foregoing second embodiment, all of which are not elaborated herein. Additionally, it is to be noted that the playback sequence of the first page and the second page may also be set according to an actual requirement, and is not particularly limited by the embodiment of the present disclosure.

### Embodiment 4

Referring to FIG. 13, the fourth embodiment of the present disclosure further provides a media playback control system 130, which includes: a memory 131 and a processor 133. The memory 131 is configured to store a program code. The processor 133 is connected to the memory 131, and is configured to invoke the program code stored in the memory 131 to execute the media playback control method including steps S11, S13 and S15 in the foregoing first embodiment, or execute the media playback control method including steps S81 and S83 in the foregoing second embodiment, or execute the media playback control method including steps S121, S123, S125 and S127 in the foregoing third embodiment. For example, the media playback control system 130 in the embodiment may be a PC machine, and may also be a display screen asynchronous device in the technical field of LED display screens like a media playback box using an ARM+FP GA architecture.

### Embodiment 5

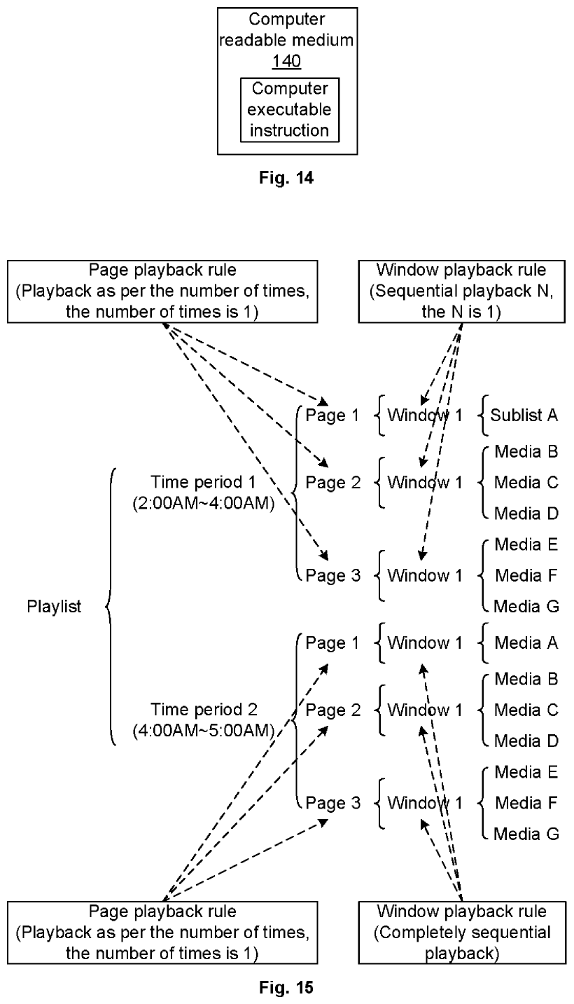

Referring to FIG. 14, the fifth embodiment of the present disclosure further provides a computer readable medium 140. The computer readable medium 140 in the embodiment may store a computer executable instruction for executing the media playback control method including steps S11, S13 and S15 in the foregoing first embodiment, or store a computer executable instruction for executing the media playback control method including steps S81 and S83 in the foregoing second embodiment, or store a computer executable instruction for executing the media playback control method including steps S121, S123, S125 and S127 in the foregoing third embodiment. In the embodiment, the computer readable medium 140 may be various nonvolatile storage media capable storing the computer executable instruction such as a U disk, a mobile hard disk, a Read-Only Memory (ROM), a magnetic disk or an optical disc.

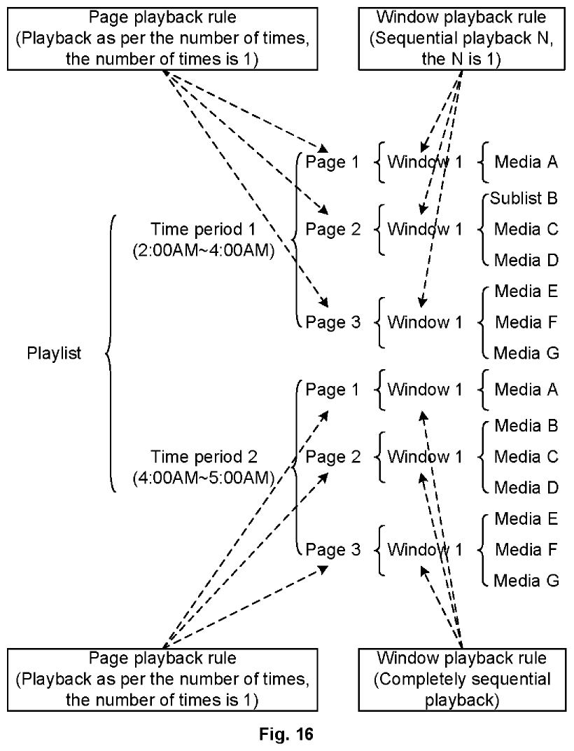

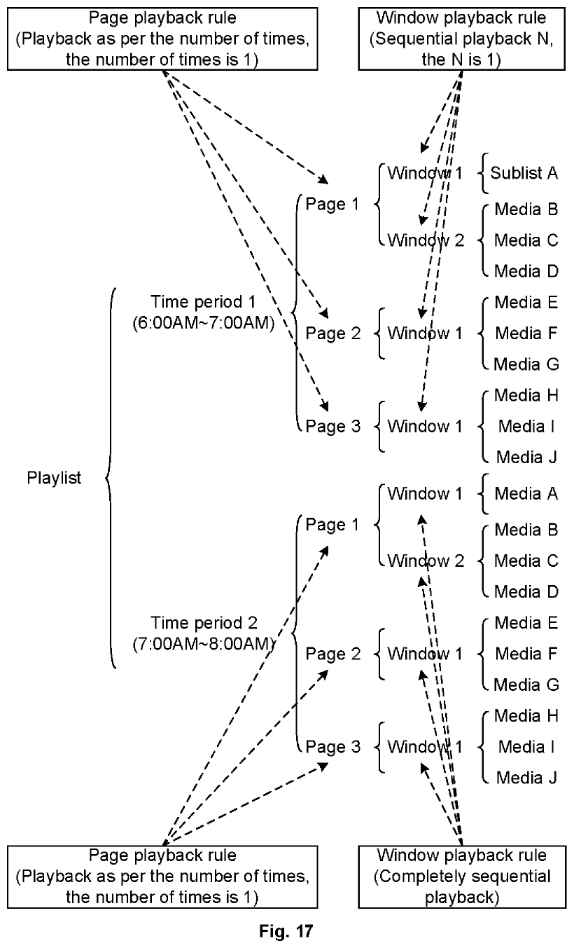

In addition, it may be understood that the above embodiments are merely illustrative description of the present disclosure; and the technical solutions of the embodiments may be combined freely and used cooperatively without departing from the objective of the present disclosure if there is no conflict in the technical feature and no contradiction in structure. For example, the sublist A in the embodiment shown in FIG. 9 is applied to the embodiment shown in FIG. 2 to replace the media A to obtain the embodiment shown in FIG. 15, or the sublist B in the embodiment shown in FIG. 9 is applied to the embodiment shown in FIG. 2 to replace the media B to obtain the embodiment shown in FIG. 16, or the sublist A in the embodiment shown in FIG. 9 is applied to the embodiment shown in FIG. 7 to replace the media A in the page 1 of the time period 1 to obtain the embodiment shown in FIG. 17.

At last, it is to be noted that the above embodiments are merely used to describe the technical solutions of the present disclosure, rather than to limit the present disclosure. Although the present disclosure is described in detail with reference to the foregoing embodiments, the person of ordinary skill in the art should understand that the technical solutions in the foregoing embodiments may still be modified or equivalent replacements are made to a part of technical features. Those modifications or replacements do not make the essence of the corresponding technical solutions depart from the spirit and scope of the technical solutions of the embodiments of the present disclosure.

### INDUSTRIAL APPLICABILITY

According to the embodiments of the present disclosure, the playback scheduling mechanism is implemented by increasing the window playback rule and re-designing the page scheduling module; by means of the scheduling mechanism, the media playback may be controlled reasonably and simply, and the media may be guaranteed to be played as per the use scenario of the user; and thus, the display screen asynchronous control device may be adapted for more application scenarios and action modes, the diversity of the played content is greatly increased, the utilization rate of the display screen is improved, and at last, the better playback effect is achieved, and the better advertisement playback effect and economic value are generated; and/or by embedding the sublist into the playlist, the freer media playback manner is provided for the user, the combination manner of the program is greatly enriched, and the user experience is good.

What is claimed is:

1. A media playback control method, comprising:
within a target time period of a playlist, playing at least one page in the target time period, wherein a window of a designated page in the at least one page is associated with a sublist and the sublist is associated with multiple media; and
when playing the window of the designated page, taking out, according to a preset playback manner of the sublist, a media identifier from a media playback management list corresponding to the sublist; and
playing the media corresponding to the media identifier in the window of the designated page after taking out the media identifier, wherein the media playback management list comprises media identifiers of the multiple medias.

2. The media playback control method as claimed in claim 1, wherein taking out, according to the preset playback manner of the sublist, the media identifier from the media playback management list corresponding to the sublist, and playing the media corresponding to the media identifier in the window of the designated page after taking out the media identifier comprises:
taking out the media identifier from the media playback management list according to a sequential playback manner, playing the media corresponding to the media identifier in the window of the designated page after taking out the media identifier, and deleting the media identifier from the media playback management list.

3. The media playback control method as claimed in claim 1, wherein taking out, according to the preset playback manner of the sublist, the media identifier from the media playback management list corresponding to the sublist, and playing the media corresponding to the media identifier in the window of the designated page after taking out the media identifier comprises:
taking out the media identifier from the media playback management list according to a random playback manner, playing the media corresponding to the media identifier in the window of the designated page after taking out the media identifier, and deleting the media identifier from the media playback management list; or
taking out the media identifier from the media playback management list according to a random playback manner, and playing the media corresponding to the media identifier in the window of the designated page after taking out the media identifier but not deleting the media identifier from the media playback management list.

4. The media playback control method as claimed in claim 1, wherein the taking out, according to the preset playback manner of the sublist, the media identifier from the media playback management list corresponding to the sublist, and playing the media corresponding to the media identifier in the window of the designated page after taking out the media identifier comprises:
taking out the media identifier from the media playback management list according to a probability playback manner, and playing the media corresponding to the media identifier in the window of the designated page after taking out the media identifier but not deleting the media identifier from the media playback management list, wherein the probability playback manner is a probability that the multiple medias associated with the sublist are respectively and randomly selected.

5. The media playback control method as claimed in claim 1, wherein the taking out, according to the preset playback manner of the sublist, the media identifier from the media playback management list corresponding to the sublist, and playing the media corresponding to the media identifier in the window of the designated page after taking out the media identifier comprises:
taking out the media identifier from the media playback management list according to a relationship playback manner, and playing the media corresponding to the media identifier in the window of the designated page after taking out the media identifier but not deleting the media identifier from the media playback management list, wherein the relationship playback manner is a playback sequence dependency relationship preset among the multiple media associated with the sublist.

6. The media playback control method as claimed in claim 1, wherein the taking out, according to a preset playback manner of the sublist, the media identifier from the media playback management list corresponding to the sublist, and playing the media corresponding to the media identifier in the window of the designated page after taking, out the media identifier comprises:
taking out the media identifier from the media playback management list according to a number-of-times playback manner, playing the media corresponding to the media identifier in the window of the designated page taking out the media identifier, and deleting the media identifier from the media playback management list when the number of times for taking out the media identifier is equal to the preset number of times.

7. The media playback control method as claimed in claim 1, further comprising:
detecting, in real time, whether current system time meets a time constraint of the at least one time period in the playlist; and
if a detection result is that the current system time meets the time constraint of the at least one time period in the playlist, determining one time period from the at least one time period as the target time period, wherein a time period having a high priority is determined as the target time period when the at least one time period is multiple time periods.

8. The media playback control method as claimed in claim 1, wherein the at least one page further comprises a second page different from the designated page, the second page has at least one window, and each window has at least one media; and the media playback control method further comprises:
in a process of playing the second page, counting the number of playback times for each media in each window of the second page, counting the number of playback times of each window in the second page and counting the number of playback times of the second page; and
recording the media playback position in each window of the second page with a unique identification number of the window as an index at the end of the playback of the second page, so as to use when playing the second page at the next time within the target time period.

9. The media playback control method as claimed in claim 8, further comprising:
in a process of playing the second page at the next time within the target time period, taking out the recorded media playback position of the window according to the unique identification number, and taking out a corresponding media according to the media playback position to play in the window.

10. A media playback control method, comprising:
within a target time period of a playlist, playing at least one page in the target time period, wherein the at least one page comprises a target page, and the target page simultaneously follows a page playback rule of the target page and a window playback rule of each window in the target page for the media playback, wherein the target page has at least one window and each window has at least one media;
in a process of playing the target page, counting the number of playback times for each media in each window of the target page, counting the number of playback times of each window in the target page and counting the number of playback times of the target page; and
recording a media playback position in each window of the target page with a unique identification number of the window as an index at the end of the playback of the target page, so as to use when playing the target page at the next time within the target time period.

11. The media playback control method as claimed in claim 10, further comprising:
in a process of playing the target page at the next time within the target time period, taking out the recorded media playback position of the window according to the unique identification number of each window, and taking out a corresponding media according to the media playback position to play in the window.

12. The media playback control method as claimed in claim 10, wherein the page playback rule is selected from playback as per the number of times, playback as per a duration and loop playback; the window playback rule is selected from completely sequential playback, completely random playback, sequential playback N and random playback N; wherein the N is a natural number and the N represents the number of media to be selected in the window.

13. A media playback control method, comprising:
within a target time period of a playlist, playing a target page in the target time period, wherein the target page comprises a first window and a second window, the first window has at least one media, the second window is associated with a sublist, and the sublist is associated with the multiple media via a media identifier in a media playback management list;
in a process of playing the target page, counting the number of playback times for each media in the first window of the target page, counting the number of playback times of the first window and counting the number of playback times of the target page, and recording a media playback position in the first window with a unique identification number of the first window as an index at the end of the playback of the target page, so as to use when playing the target page at the next time within the target time period; and
in a process of playing the target page, taking out the media identifier from the media playback management list according to a preset playback manner of the sublist, and playing the media corresponding to the media identifier in the second window after taking out the media identifier.

14. (canceled)

15. (canceled)

16. The media playback control method as claimed in claim 13, wherein taking out the media identifier from the media playback management list according to a preset playback manner of the sublist, and playing the media corresponding to the media identifier in the second window after taking out the media identifier comprises:
taking out the media identifier from the media playback management list according to a sequential playback manner, playing the media corresponding to the media identifier in the second window after taking out the media identifier, and deleting the media identifier from the media playback management list.

17. The media playback control method as claimed in claim 13, wherein taking out the media identifier from the media playback management list according to a preset playback manner of the sublist, and playing the media corresponding to the media identifier in the second window after taking out the media identifier comprises:
taking out the media identifier from the media playback management list according to a random playback manner, playing the media corresponding to the media identifier in the second window after taking out the media identifier, and deleting the media identifier from the media playback management list; or
taking out the media identifier from the media playback management list according to a random playback manner, and playing the media corresponding to the media identifier in the second window after taking out the media identifier but not deleting the media identifier from the media playback management list.

18. The media playback control method as claimed in claim 13, wherein taking out the media identifier from the media playback management list according to a preset playback manner of the sublist, and playing the media corresponding to the media identifier in the second window after taking out the media identifier comprises:
taking out the media identifier from the media playback management list according to a probability playback manner, and playing the media corresponding to the media identifier in the second window after taking out the media identifier but not deleting the media identifier from the media playback management list, wherein the probability playback manner is a probability that the multiple medias associated with the sublist are randomly selected.

19. The media playback control method as claimed in claim 13, wherein taking out the media identifier from the media playback management list according to a preset playback manner of the sublist, and playing the media corresponding to the media identifier in the second window after taking out the media identifier comprises:
taking out the media identifier from the media playback management list according to a relationship playback manner, and playing the media corresponding to the media identifier in the second window after taking out the media identifier but not deleting the media identifier from the media playback management list, wherein the relationship playback manner is a playback sequence dependency relationship preset among the multiple media associated with the sublist.

20. The media playback control method as claimed in claim 13, wherein taking out the media identifier from the media playback management list according to a preset playback manner of the sublist, and playing the media corresponding to the media identifier in the second window after taking out the media identifier comprises:
taking out the media identifier from the media playback management list according to a number-of-times playback manner, playing the media corresponding to the media identifier in the second window after taking out the media identifier, and deleting the media identifier from the media playback management list when the number of times for taking out the media identifier is equal to the preset number of times.

21. The media playback control method as claimed in claim 13, further comprising:
in a process of playing the target page at the next time within the target time period, taking out the recorded media playback position of the first window according to the unique identification number, and taking out a corresponding media according to the media playback position to play in the first window.
